(19) United States
(12) Patent Application Publication
(10) Pub. No.: US 2009/0152320 A1
(43) Pub. Date: Jun. 18, 2009

(54) Stapler

(76) Inventor: Chih-Wei Hu, Taipei City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/956,505

(22) Filed: Dec. 14, 2007

(51) Int. Cl. B25C 5/06

(52) U.S. Cl. 227/132

(57) ABSTRACT

A stapler comprises a body including two holes formed on two sidewalls thereof and a link defined on one sidewall thereof; a magazine assembly installed in the bottom of the body; a handle assembly including a handle lever formed on an end thereof a handle stop defined on another end thereof a link and a through hole between the handle lever and the handle stop, a connector disposed in the link thereof and respectively pivotally coupling to the holes, and a first roller inserting through the through hole and moving rotatably in the link of the body; a power spring disposed in the body; and a plunger including a first hole and a second hole; wherein while the handle lever is pressed downwardly and the handle stop lifts the plunger upwardly, the first roller is driven to move rotatably in the link of the body as to detach the handle stop from the plunger gradually.

### BACKGROUND OF THE INVENTION

1. Field of the Invention

The present invention relates to a stapler.

2. Description of the Related Art

Referring to FIG. 6, a known stapler includes a base portion 91, a magazine 92 installed to the bottom of the base portion 91, and a handle portion 93 pivotally coupling to a pivot point (not numbered) of the base portion 91 and being adjustably movable relative to said pivot point. Moreover, an end of the handle portion 93 connects to and drives a plunger 94, and another end of the handle portion 93 is exposed from the base portion 91. A power spring 95 is disposed in the base portion 91 and couples to the plunger 94 so as to limit the handle portion 93.

While the handle portion 93 is pressed downwardly, the plunger 94 is lifted and drives the power spring 95 upwardly. Because of the reaction of the power spring 95, the lower position of the handle portion 93 is downwardly pressed to the larger strength forces to the handle portion 93. However, when the handle portion 93 is pressed to the lowest position, the position of said pivot point is adjustable relative to the handle portion 93 so as to force the handle portion 93 detach from the plunger 94. Next, the staple function is done.

The foregoing shows that the handle portion is pressed to approach the lowest position, and the reaction of the power spring 95 is largest meanwhile. Hence, it's difficult for a user to move the handle portion 93 relative to said pivot point to detach from the plunger 94. Furthermore, the user has to exert a huge force to operate for stapling so that there will be a loud noise. And the known stapler is easy to be broken by forcing excessively.

The present invention is therefore intended to obviate or at least alleviate the problems encountered in prior art.

### SUMMARY OF THE INVENTION

The present invention solves this need and other problems in the field of stapler by providing, in a preferred form, a stapler including a body, a magazine assembly installed in the bottom of the body, a handle assembly pivotally coupling to the body, an elongate power spring disposed in the body between the magazine assembly and a handle assembly, a plunger respectively connected to the elongate power spring and the handle assembly, and a buffer device installed on the connection of the elongate power spring and the plunger.

The handle assembly includes a link, a first and a second rollers and a connector. And the body further includes two holes formed on two sidewalls thereof and respectively corresponding to the link of the handle assembly, and a link formed on one of the sidewalls and receiving the first roller. The connector inserts through one hole and the second roller to another hole.

When the handle assembly is pressed downwardly, the position of the second roller with the connector as a pivot changes positions for pressing force reduce; in the meanwhile, the handle lever is pressed downwardly and the handle stop lifts the plunger upwardly, the first roller is driven to move rotatably in the link of the body as to detach the handle stop from the plunger gradually.

Other advantages, objectives and features of the present invention will become apparent from the following description referring to the attached drawings.

### BRIEF DESCRIPTION OF THE DRAWINGS

The detailed description and technical characteristics of the present invention and described together with the drawings as follows.

FIG. 1 is a perspective view of a stapler in accordance with the preferred embodiment of the present invention.

FIG. 2 is an exploded view of a stapler in accordance with the preferred embodiment of the present invention.

FIG. 3 is a sectional view taken along plane 3-3 in FIG. 1.

FIG. 4 is a sectional view similar to FIG. 3, illustrating the handle assembly detaching from the plunger gradually.

FIG. 5 is a sectional view similar to FIG. 4, illustrating the handle assembly being detached from the plunger.

FIG. 6 is a perspective view of a known stapler.

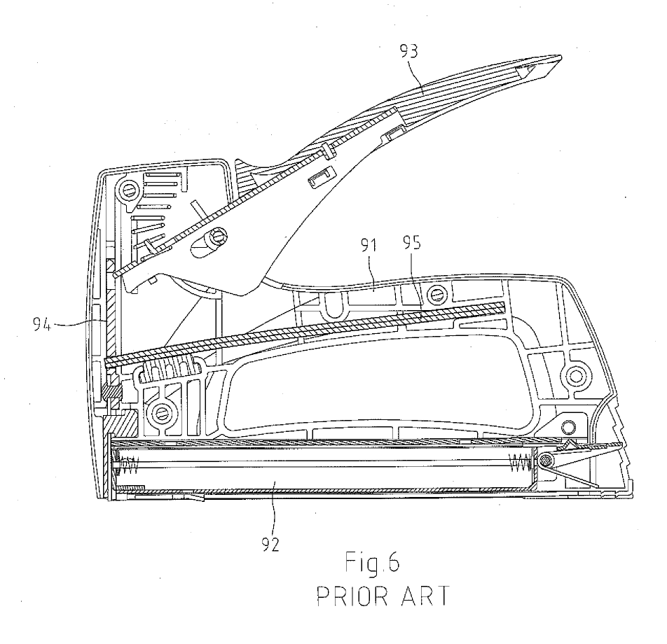

### DETAILED DESCRIPTION OF THE PREFERRED EMBODIMENT

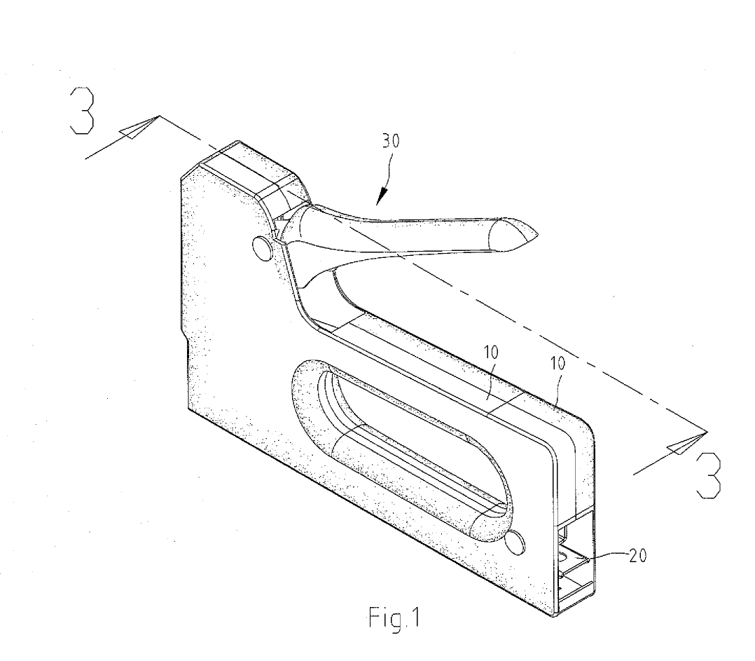

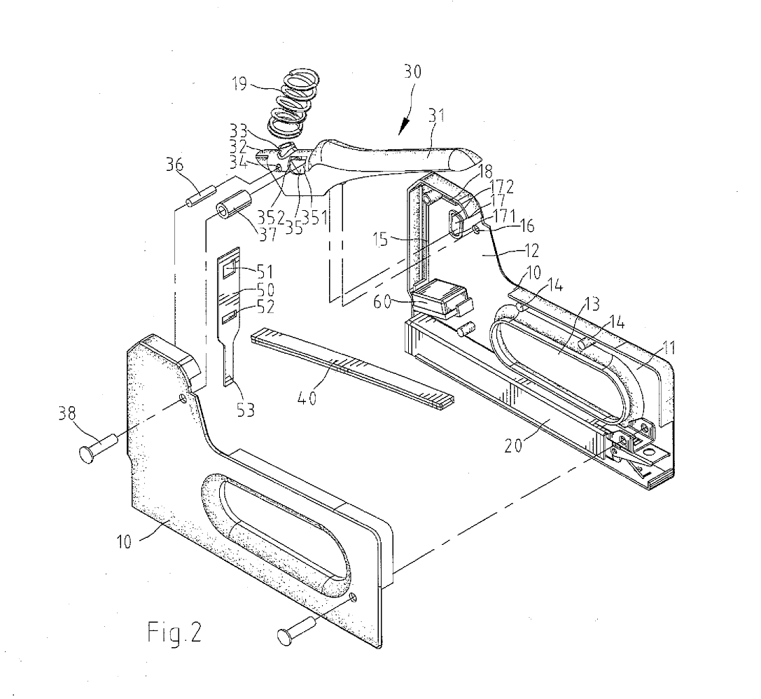

Referring to FIGS. 1 and 2, a stapler in accordance with the preferred embodiment in the present invention includes a body 10 that consists of two shell halves, a magazine assembly 20 disposed in the bottom of the body 10, a handle assembly 30 pivotally disposed in the body 10, an elongate power spring 40 provided between the handle assembly 30 and the magazine assembly 20, a plunger 50 respectively connected to the elongate power spring 40 and the handle assembly 30, and a buffer device 60 installed adjacent to the connection of the elongate power spring 40 and the plunger 50.

The body 10 includes a base portion 11, a head portion 12, a holding portion defined on the base portion 11 and adapted for a user's hand to grip, and two limited portions 14 formed therein between the holding portion 13 and the upper outer periphery of the body 10. The two limited portions 14 are adapted for being a distance apart. The body further includes a plunger ledge 15 defined adjacent to the front of the head portion 12, two holes 16 respectively formed on two sidewalls of the head portion 12, a link 17 formed on one of said sidewalls, a spring ledge 18 provided adjacent to the upper periphery of the head portion 12, and a return spring mounted on the spring ledge 18.

The link 17 is defined between the spring ledge 18 and the buffer device 60; the link 17 is defined between the plunger 50 and the holes 16, too. Moreover, the link 17 has a first end 171 extending toward the buffer device 60, and a two second end 172 extending toward the spring ledge 18. In addition, the profile of the link 17 can be various.

The handle assembly 30 includes a handle lever 31 formed on an end thereof, a handle stop 32 formed on another end thereof, a spring anchor 33 defined on the outer periphery thereof adjacent to the handle stop 32, and a through hole 34 and a link 35 defined therethrough. The return spring 19 is disposed between the spring ledge 18 and the spring anchor 33. A first roller 36 is adapted to insert through the through hole 34 to the link 17 of the body 10. A second roller 37 is disposed through the link 35 of the handle assembly 30. A connector 38 is adapted to insert through one hole 16 and the second roller 37 to another hole 16 as to fix two halves of the body 10 to one another. Moreover, the link 35 of the handle assembly 30 includes a first end 351 adjacent to the handle lever 31, and a second end 352 adjacent to the handle stop 32.

An end of the elongate power spring 40 is limited to be placed above the two limited portions 14, and another end of the elongate power spring 40 insert to the plunger 50.

The space that is defined between the plunger ledge 15 and the periphery of the body 10 is adapted to receive the plunger 50. Therefore, the plunger 50 is limited not to move transversely and only moves longitudinally on the ledge 15 by driven with the handle assembly 30. The plunger 50 includes a first hole 51 and a second hole 52 formed thereon, and a firing portion 53 defined on the distal end thereof. The handle stop 32 of the handle assembly 30 inserts to the first hole 51; meanwhile, the second hole 52 is adapted for the elongate power spring 40 inserting thereto.

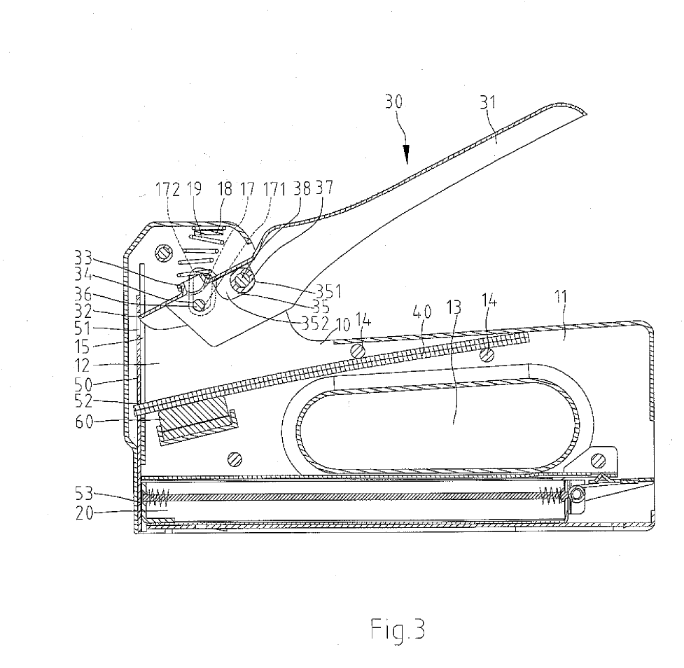

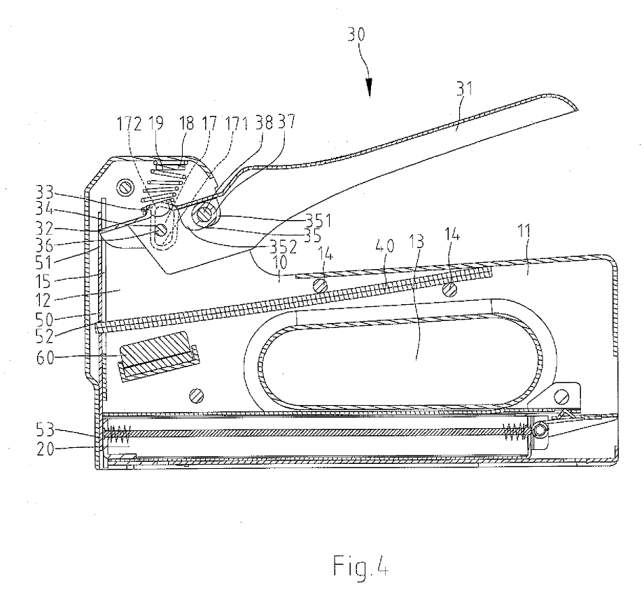

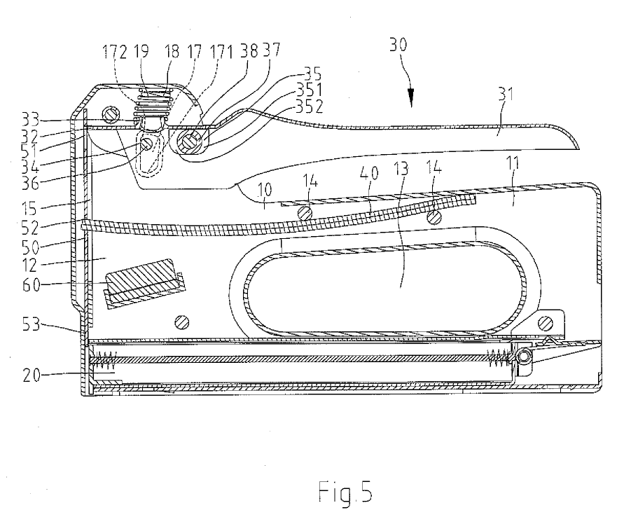

Referring to FIGS. 3 to 5, in operation, the user grips on the holding portion 13 of the body 10 and presses the handle lever 31 of the handle assembly 30, and the handle assembly 30 pivots with respect to the second roller 37 and the connector 38 for driving the plunger 50 to staple. While the handle lever 31 is in the highest position, the second roller 37 with the connector 38 locate on the first end 351 of the link 35, and the first roller 37 locates on the first end 171 of the link 17.

To continue pressing the handle lever 31, the second roller 37 with the connector 38 move toward the second end 352 of the link 35 gradually, and the first roller 36 rotates toward the second end 172 along the inner periphery of the link 17.

When the handle lever 31 is pressed downwardly, the handle stop 32 is lifted upwardly as to detach the handle stop 32 from the first hole 51 of the plunger 50 gradually. However, while the handle lever 31 is pressed to the lowest position, the handle stop 32 detaches from the first hole 51 of the plunger 50 completely. Simultaneously, the plunger 50 is driven to dump via the released power spring 40 for stapling. Moreover, the buffer device 60 is provided to block the power spring 40 that falls downwardly for preventing the power spring 40 from hitting the body 10 of the stapler so that it can reduce the noise during stapling.

At last the stapling function is done, the handle assembly is free and the return spring 19 is released for returning the handle assembly 30 in the original position.

While pressing the handle assembly 30, the handle lever 31 pivots on the second roller 37 with the connector 38 as a pivot point which position is changeable. And the torque arm of exerting increases as a result that the second roller 37 moving toward the handle stop 32, therefore, it reduces the force for exerting to staple and achieves a purpose of saving-strength. In the meanwhile, the first roller 36 moves along the inner periphery of the link 17 of the body 10 from the first end 171 to the second end 172. The first roller 36 moves with the handle lever 31 and drives the handle stop 32 to move out of the hole 51 of the plunger 50 little by little. So that when the handle lever 31 is pressed downwardly, the handle stop 32 detaches from the plunger 50 gradually. Because the handle stop 32 of the handle assembly 30 detaches from the plunger 50 before the handle stop 32 is in the highest position. Thus, the plunger 50 falls down stably to fire nails.

In addition, the handle assembly gradually detaches from the plunger 50, and the plunger 50 does not hit in the body 10 with violence and hence reduce the waste of parts of stapler and increase the use-life.

What is claimed is:

1. A stapler comprising:
a body including two holes formed on two sidewalls thereof and a link defined on one sidewall thereof;
a magazine assembly installed in the bottom of the body;
a handle assembly including a handle lever formed on an end thereof, a handle stop defined on another end thereof, a link and a through hole between the handle lever and the handle stop, a connector disposed in the link thereof and respectively pivotally coupling to the holes, and a first roller inserting through the through hole and moving rotatably in the link of the body;
a power spring disposed in the body; and
a plunger including a first hole and a second hole;
wherein the handle stop of the handle assembly inserts to the first hole, and an end of the power spring inserts to the second hole;
wherein while the handle lever is pressed downwardly and the handle stop lifts the plunger upwardly, the first roller is driven to move rotatably in the link of the body as to detach the handle stop from the first hole of the plunger gradually.

2. The stapler as claimed in claim 1, wherein further comprises a second roller, with the connector inserting through one hole of the body and the second roller to another hole of the body.

3. The stapler as claimed in claim 1, wherein further comprises a return spring between the body and the handle stop.

4. The stapler as claimed in claim 3, wherein the handle assembly includes a spring anchor, and the body includes a spring ledge; with the return spring limited between the spring anchor and the spring ledge.

5. The stapler as claimed in claim 1, wherein further comprises a buffer device disposed in the connection of the plunger and the power spring.

6. The stapler as claimed in claim 1, with the link of the body defined between the holes and the plunger.

7. The stapler as claimed in claim 1, wherein further comprising a second roller adapted for receiving the connector.

8. The stapler as claimed in claim 1, with the link of the handle assembly having a first end and a second end, with the connector moving between the first and second ends in the link of the handle assembly when pressing the handle lever downwardly.
